(19) United States
(12) Patent Application Publication
(10) Pub. No.: US 2025/0290359 A1
(43) Pub. Date: Sep. 18, 2025

(54) DOOR HINGE AND BUILDING DOOR

(71) Applicant: Simonswerk GmbH, Rheda-Wiedenbrück (DE)

(72) Inventors: Jörg ELLEFRED, Rheda-Wiedenbrück (DE); Felix KAUPMANN, Rheda-Wiedenbrück (DE)

(21) Appl. No.: 19/074,756

(22) Filed: Mar. 10, 2025

(30) Foreign Application Priority Data
Mar. 15, 2024 (DE) 10 2024 107 510.4

(51) Int. Cl. E05D 3/06; E05D 5/02

(52) U.S. Cl. CPC E05D 3/06; E05D 5/02

(57) ABSTRACT

Disclosed is a door hinge having an at least six-pin hinge system, which is connected, on a first side, by way of a first and a second pin extending along a vertical direction to a first support and fastening system with a receiving body and, on a second side, by way of a third and a fourth pin extending along the vertical direction to a second support and fastening system. The second support and fastening system has two separate support and fastening sections which are not connected directly but via the third and fourth pins and which are configured to be arranged with a rear fastening surface directly on a door or frame surface.

### CROSS-REFERENCE TO RELATED APPLICATIONS

Not applicable.

### FIELD OF THE INVENTION

The invention relates to a door hinge comprising an at least six-pin hinge system, which is connected, on a first side, by way of a first and a second pin extending along a vertical direction to a first support and fastening system with a receiving body and, on a second side, by way of a third and a fourth pin extending along the vertical direction to a second support and fastening system. The invention also relates to a building door comprising a door frame, a door leaf, and at least two of the above-described door hinges.

The door hinge preferably has six, and possibly even seven, pins. Corresponding door hinges are frequently provided for a concealed arrangement, wherein the two support and fastening systems are mounted on the narrow side of a door leaf and a reveal side of a door frame for this purpose. In the closed position, the door hinge is then not visible or is at most only visible to a small extent through a lateral gap between the door leaf and door frame. Corresponding door hinges then allow a particularly attractive design of building doors and, in particular of interior building doors. However, a use for exterior doors is also generally conceivable. Corresponding door hinges are also referred to as hidden door hinges or concealed door hinges.

The door hinge is suitable for all types of interior doors, with the concealed arrangement making it particularly suitable for use in upscale construction projects. Corresponding door hinges are also referred to in practice as heavy-duty hinges.

### BACKGROUND OF THE INVENTION

Door hinges of the type in question are known, for example, from DE 10 2021 126 914 B3 and WO 2022/020867A1 in a six-pin design. In these six-pin designs, a degree of freedom results from one of the pins being movable along a guide path. This guide path can extend in either a straight or a curved manner.

EP 3 683 391 A1 discloses a seven-pin design. In a seven-pin design, a scissor-like movement takes place in the broadest sense, with only a rotation being provided on all pins.

For the purpose of simple installation, a low installation depth is often sought on the support and fastening system to be arranged on the frame side. Depending on the design, door frames in particular can only provide a low installation depth, for example if masonry or the like adjoins the frames.

Against this background, WO 2022/020867 A1 already discloses a door hinge comprising a six-pin hinge system, which is asymmetrical to a considerable degree with regard to the installation depth in the door leaf and the door frame. The first support and fastening system comprises an optionally multi-piece receiving body, which can also be designed to be adjustable. A guide path for the hinge system is then also formed in the receiving body. A receiving body is also provided on the second support and fastening system; however, it has a comparatively flat design. As a result, it is also possible to place the frame-side receiving body on the reveal side of a door frame without a milled recess (see FIG. 5). The corresponding receiving body can then also form a stop for the hinge system.

These and other objects and advantages of the present invention will become apparent from a reading of the attached specification and appended claims.

### SUMMARY OF THE INVENTION

It is the object of the present invention to provide a door hinge of the type in question, which can be manufactured in a particularly compact manner and with low material use and yet has favorable functional properties. Furthermore, a building door comprising at least two, and preferably exactly two, corresponding door hinges is also to be provided.

The subject matter of the invention and the solution to the problem are a door hinge a building door according to the independent claims.

Proceeding from a door hinge of the type in question, it is accordingly provided according to the invention that the second support and fastening system comprises two separate support and fastening sections which are not connected directly but via the third and fourth pins and which are configured to be arranged with a rear fastening surface directly on a door or frame surface.

As a result, a continuous receiving body for the door hinge itself is dispensed with on the second support and fastening system, which is intended in particular for mounting on the frame surface. Rather, the two support and fastening sections are manufactured as separate components, wherein these are preferably attached exclusively above or below the hinge system relative to the vertical direction.

In contrast to known inserts or the like, the two separate support and fastening sections are also configured to be arranged with the rear fastening surface thereof directly on the door surface or preferably the frame surface. The fastening surface can be designed to be essentially flat for this purpose; however, a corrugation and/or at least one centering pin can also be provided.

Within the scope of the invention, it is accepted that, apart from the connection via the third and fourth pins, no further connection is provided between the two supporting and fastening sections of the door hinge itself. However, the third and fourth pins already provide a certain level of support on two separate areas.

It is also possible for the third and fourth pins or the stems forming the pins to be pressed or fixed in another manner in the associated receptacles of the support and fastening sections. Pressing can be achieved, for example, by the third and fourth pins having an oversized dimension and/or a corrugation and/or another contour in relation to the associated receptacles.

So as to then achieve further fixation via the material of the adjacent door or frame surface in the mounted state, the rear fastening surface can optionally be designed with the previously described corrugation and/or at least one centering pin.

A corrugation can extend horizontally so as to then bury itself into the adjacent material of the door or frame surface to a certain degree during installation, whereby stabilization is achieved, in particular in the vertical direction.

If stabilization or fixation via centering pins is provided, the support and fastening sections preferably comprise two centering pins, so that the position of the support and fastening sections is already predefined by the centering pins. Especially within the scope of such a design, it is readily possible for the support and fastening sections to each have exactly one opening for a fastening means. However, the design comprising only one fastening means is also generally possible without the provision of centering pins.

According to one variant of the invention, the support and fastening sections can also have two openings for a fastening means, so that better fixation is then achieved when two fastening means are arranged and, for example, twisting is also avoided. However, since—as will be described in more detail below—the support and fastening sections should preferably be very compact, a design having exactly one opening for a fastening means on each support and fastening section is particularly preferred, wherein in general at least no more than two openings for fastening means are provided.

Since the support and fastening sections are preferably located completely above or completely below the hinge system based on the vertical direction, the hinge system directly abuts the door or frame surface located therebeneath via a gap in the mounted state. As a result, the installation height perpendicular to the vertical direction can be further minimized by minimizing this gap.

According to a preferred embodiment of the invention, it is provided that the support and fastening sections have a total thickness, perpendicular to the vertical direction, of between only 5 mm and 16 mm, wherein a width can range between 15 mm and 40 mm, for example. The height of the support and fastening sections along the vertical direction can, for example, range between 15 mm and 40 mm.

In the interest of high stability in the mounted state and a simple, compact design, it is also provided according to a preferred embodiment of the invention that the second support and fastening system is configured for a rigid, non-adjustable arrangement on the door or frame surface.

In contrast, the first support and fastening system can be adjustable. An adjustment can, for example, be provided by elongated holes in the receiving body. Such an adjustment can then be carried out in a vertical direction or in a horizontal direction.

For further adjustment, the hinge system can also be supported on the first support and fastening system by way of two inserts or a shared insert, wherein the inserts or the insert can then be adjustable with respect to the receiving body. This, in particular, enables adjustment in a second horizontal direction, which extends along the width of the door leaf when the door is closed. During an adjustment, the door leaf can then be adjusted laterally within the frame so as to be able to set an equal gap on both sides of the door, for example.

According to a preferred embodiment, it is provided that the support and fastening sections each comprise a support region for receiving the third and fourth pins, and a preferably substantially plate-shaped fastening region. The support region can then have a greater thickness so as to form pin receptacles.

The fastening region is then plate-shaped or substantially plate-shaped. In a deviation from the plate shape, the above-described corrugation and/or at least one centering pin can be provided on the rear fastening surface, for example.

The thickness of the fastening region can be between 2.5 mm and 8 mm, for example. If centering pins are provided, the thickness tends to be in the upper range of 5 mm to 8 mm. Without centering pins or when determined outside the centering pins, the thickness is preferably 2.5 mm to 4.5 mm.

Within the scope of the invention, a particularly compact design is to be made possible in order to allow the door hinge to be arranged in a narrow gap between the door frame and the door leaf, it also preferably being possible to dispense with milling either in a door leaf or preferably in the door frame.

Against this background, according to a preferred embodiment of the invention, it is provided that, in a closed position, the first support and fastening system and the second support and fastening system form a stepped spacer gap, the first support and fastening system having a setoff, relative to a horizontal direction perpendicular to the spacer gap, in which the support and fastening sections of the second support and fastening system engage with a protrusion. As a result, an overlap or mutual engagement is thus present, relative to an imaginary center plane between the support and fastening system. Against this background, for example, it may be provided that the above-described support region of the support and fastening sections forms the protrusion so as to then be able to arrange the third and fourth pins in a particularly compact manner.

Furthermore, it may also be provided that the first support and fastening system comprises cover plates arranged along the vertical direction, each of which has at least one step. For example, it may be provided that the first support and fastening system extends along the vertical direction over a greater overall height than the second support and fastening system. The step of the cover plates can then be provided, for example, where the cover plates extend beyond the support and fastening sections of the second support and fastening system in the vertical direction in the closed position.

According to a preferred embodiment of the invention, the hinge system has exactly six pins.

It may be provided that the hinge system comprises a main arm, a first partial arm, and a second partial arm. Preferably, the main arm is then connected at the first pin to the first support and fastening system so as to be rotatable and displaceable along a guide path, and is connected at the third pin to the second support and fastening system so as to be rotatable only. The first partial arm is connected at the second pin to the first support and fastening system so as to be rotatable only, and is connected at a fifth pin extending along the vertical direction to the main arm so as to be rotatable only, and is connected at a sixth pin extending along the vertical direction to the second partial arm so as to be rotatable only. Furthermore, it is provided that the second partial arm is connected at the fourth pin to the second support and fastening system so as to be rotatable only.

The support and fastening sections can be designed as cast metal parts, for example. When manufactured by metal casting, a certain undersize can also easily be set or a structuring can be provided when creating the above-described pin receptacles so as to then enable pressing together with the third and/or fourth pins.

Within the scope of the invention, the door hinge preferably enables a maximum opening angle of more than 160°, in particular approximately 180°, despite the compact design.

The invention also relates to a building door comprising a door frame, a door leaf, and at least two, preferably exactly two, door hinges, which are designed as described above. The building door is preferably an interior door, although the door hinge according to the invention can, in principle, also be suitable for an exterior door.

On the building door, the door hinges are preferably arranged in such a way that the first support and fastening system is in each case inserted into a recess in a narrow side of the door leaf. The second support and fastening system of each door hinge is then placed on a reveal side of the door frame so that the door hinges are at least substantially concealed when the door leaf is closed. The door leaf usually has a typical weight for building doors between 15 kg and 120 kg, and in particular between 20 kg and 80 kg.

It is particularly preferred that the second support and fastening system is fastened to partial surfaces of a flat, continuous reveal side of the door frame, so that no milled-out portions or the like are then necessary.

However, the invention is not limited to such an embodiment. For example, doors are known in which the door frame already has a flat milling, for example so as to be able to receive a hinge flap resting flat thereon. So as to compensate for the milled recess that is then essentially no longer required, a spacer plate or the like can also be provided as an accessory, for example, on which the support and fastening sections of the second support and fastening system are then arranged.

### BRIEF DESCRIPTION OF DRAWINGS

FIG. 1 shows a door hinge according to the invention in the mounted state with an open door.

FIG. 2 shows the door hinge alone in a rear view in the open state.

FIG. 3 shows a horizontal section through a closed door at half the height of the door hinge.

FIG. 4 shows a section corresponding to FIG. 3 with an open door leaf.

FIG. 5 shows a horizontal section of a closed door below a hinge system of the door hinge.

FIG. 6 shows a partial view of the door hinge in a longitudinal section along a vertical direction.

### DETAILED DESCRIPTION OF THE INVENTION

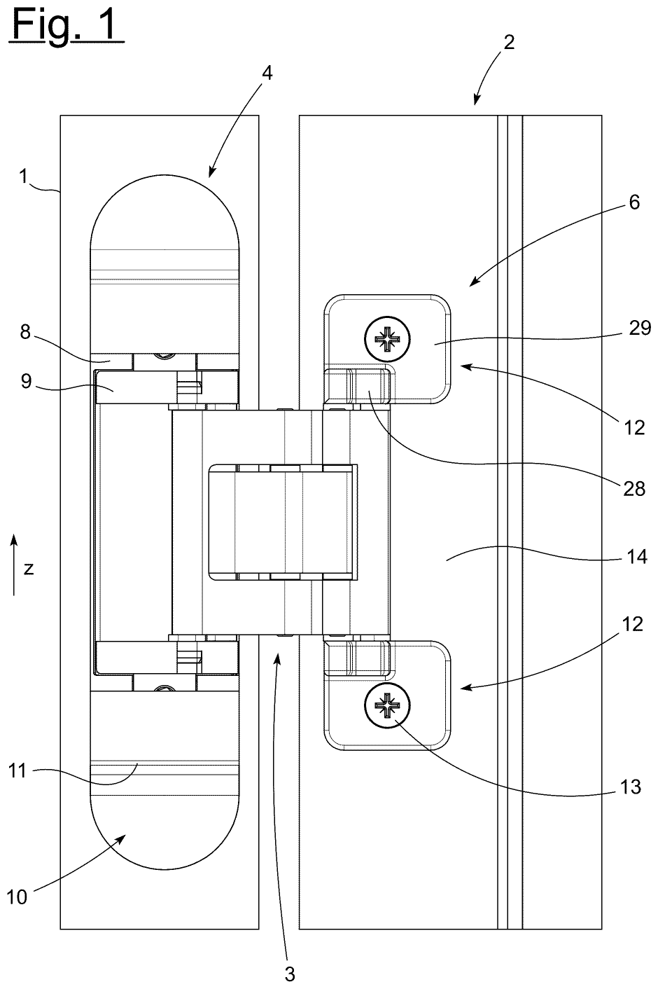

FIG. 1 shows a section of a door in the region of a door hinge, which connects a door leaf 1 to a door frame 2. As will also be described in greater detail hereafter, the door hinge comprises a six-pin hinge system 3, which is attached to a door leaf 1 by way of a first support and fastening system 4 and to a door frame 7 by way of a second support and fastening system 6. The entire door comprises two of the door hinges shown.

It is already apparent from FIG. 1, the first support and fastening system 4 comprises a receiving body 8, wherein the hinge system 3 is held on the receiving body 8 via a one-piece insert 9. Furthermore, cover plates 10 are provided at the ends of the first support and fastening system 4 along a vertical direction z, which each comprise a horizontally extending step 11.

It is already apparent from FIG. 1, the second support and fastening system 6 comprises two separate support and fastening sections 12, which are each fastened to the door frame 2 by way of a screw 13.

Specifically, the fastening is made to a flat, continuous reveal surface 14 of the door frame 2.

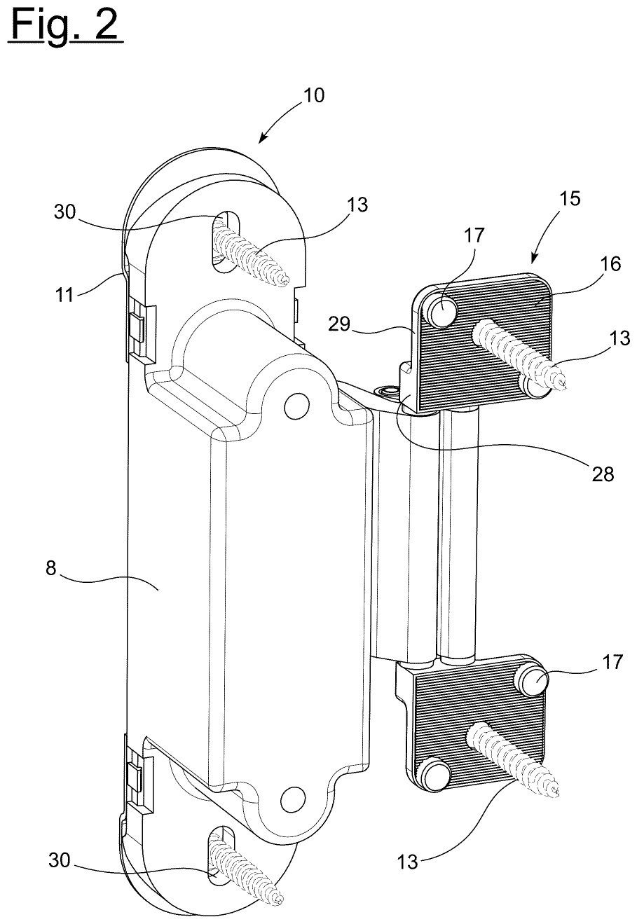

FIG. 2 shows the open door hinge without the door leaf 1 and the door frame 2 in a perspective rear view.

It is apparent that the support and fastening sections 12 overall are designed to be flat, having a low overall thickness of between 5 mm and 16 mm, for example, with a horizontally extending corrugation 16 and two centering pins 17 being provided on a rear fastening surface 15. Both the corrugation 16 and the centering pins 17 represent optional designs which are provided for improved fixation of the two support and fastening sections 12. The reason is that, according to the invention, no shared connecting body of the second support and fastening system 6 is provided.

The provision of two centering pins 17 can in particular also prevent the support and fastening sections 12 from twisting about the single screw 13 in each case.

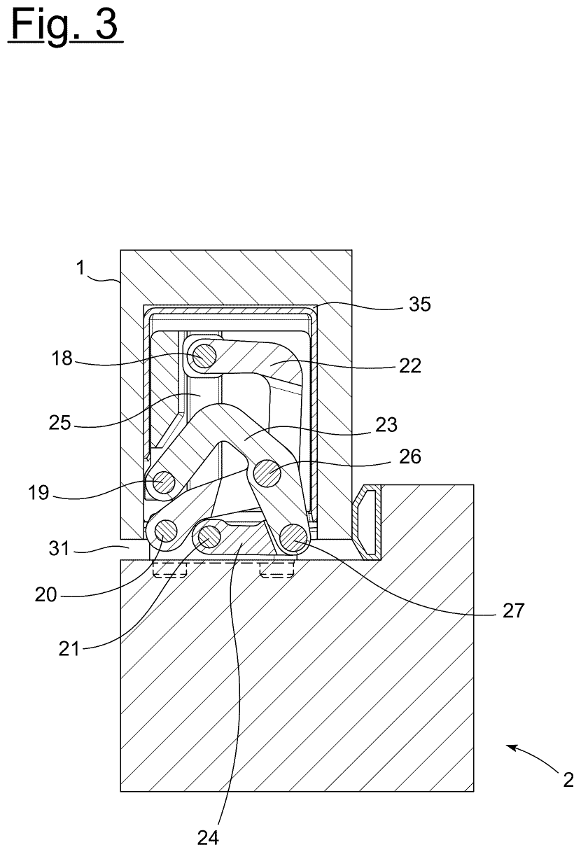

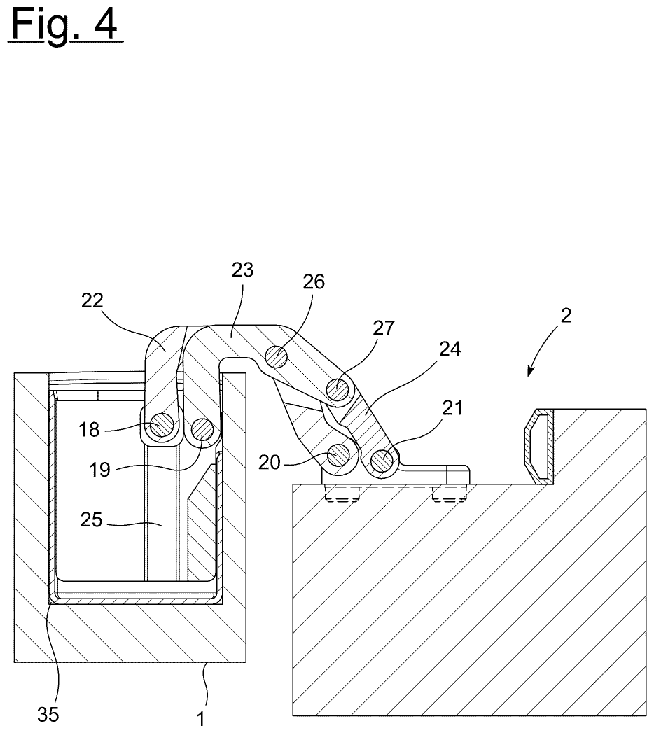

Further details of the hinge system 3 can, in particular, also be derived from FIGS. 3 and 4.

The hinge system is connected to the first support and fastening system 4 by way of a first pin 18 and a second pin 19. Furthermore, the hinge system 3 is connected to the second support and fastening system 6 by way of a third pin 20 and a fourth pin 21.

In particular, a comparison of FIG. 1 with FIG. 3 shows that the hinge system 3 comprises a main arm 22, a first partial arm 23, and a second partial arm 24.

The main arm 22 is connected at the first pin 18 to the first support and fastening system 4 so as to be rotatable and displaceable along a guide path 25, and is connected at the third pin 20 to the second support and fastening system 6 so as to be rotatable only.

The first partial arm 23 is connected at the second pin 19 to the first support and fastening system 4 so as to be rotatable only, is connected at a fifth pin 26 to the main arm 22 so as to be rotatable only, and is connected at a sixth pin 27 to the second partial arm 24 so as to be rotatable only. Furthermore, the second partial arm 24 is connected at the fourth pin 21 to the second support and fastening system 6 so as to be rotatable only.

The hinge system 6 thus has exactly six pins. All pins 18, 19, 20, 21, 26, 27 extend along the vertical direction z.

FIG. 4 shows a section corresponding to FIG. 3 with a completely open door hinge, which allows an opening angle of 180°.

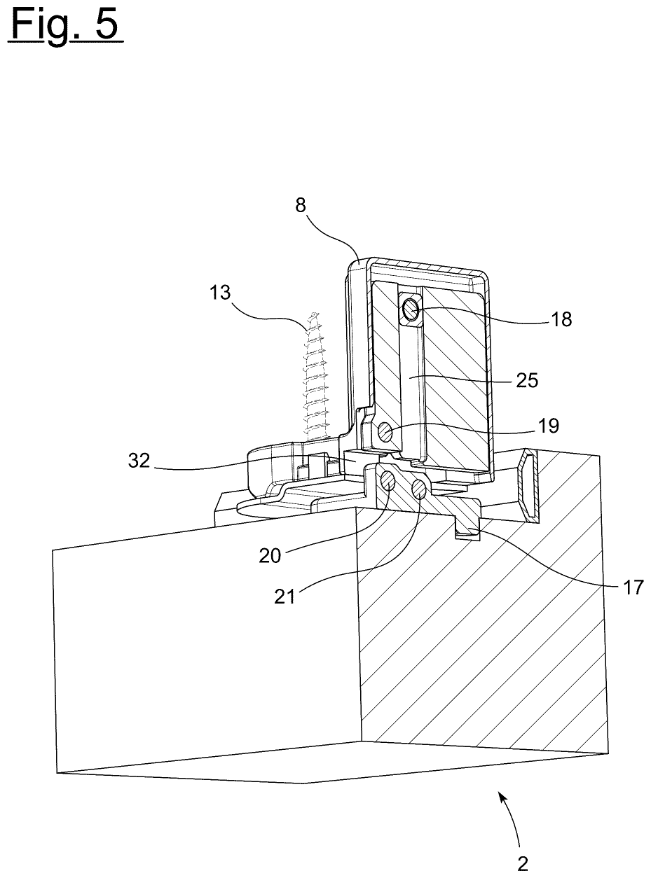

FIG. 5 shows a horizontal section below the hinge system 3, so that the further details of the support and fastening sections 12 become even clearer here, particularly in combination with FIG. 1 and FIG. 2. The door leaf 1 is not shown to ensure a better understanding.

It is apparent that the support and fastening sections 12 each comprise a support region 28 for receiving the third and fourth pins 20, 21 and a substantially plate-shaped fastening region 29.

As was already explained above, the total thickness of the support and fastening sections 12 can range between 5 mm and 16 mm in total, with the support region 28 protruding outward in relation to the fastening region 29 so as to provide sufficient space for receiving the third and fourth pins 20, 21. The support and fastening sections 12 can, for example, have a width between 15 mm and 40 mm and a height along the vertical direction between 15 mm and 14 mm.

The second support and fastening system 6 including the two separate support and fastening sections 12 is also configured for a rigid, non-adjustable arrangement on the door frame 2 in order to achieve the simplest and most stable design and construction possible.

In contrast, an adjustment can be provided on the first support and fastening system 4. For example, it is apparent from FIG. 2 that the screws 13 on the first support and fastening system are arranged in elongated holes 30, which extend along the vertical direction z. Accordingly, a certain degree of adjustment is possible along the elongated holes 13 when the screws 13 are not tightened.

Furthermore, it is indicated in FIG. 1 that the hinge system 3 is supported on the receiving body 8 by way of the insert 9, wherein an adjustment in the horizontal direction can be provided for this purpose in a manner known per se. For example, the lateral distance between the door leaf 1 and the door frame 2 can be adjusted relative to the gap 31 shown in FIG. 3.

With the above-described division of the support and fastening sections 12 into the support region 28 and the fastening region 29, in particular a thickness between 2.5 mm and 8 mm results on the fastening region.

In the shown specific embodiment comprising optional centering pins 17, these must then also be taken into account when determining the thickness, wherein the thickness with centering pins 17 is then usually between 5 mm and 8 mm. Without centering pins 17 or when determined outside the centering pins 17, the thickness of the fastening region then ranges between 2.5 mm and 4.5 mm, for example.

Since one of the support and fastening sections 12 is arranged completely above and the other support and fastening section 12 is arranged completely below the hinge system 3, the hinge system 3 can also be lowered into the region between the support and fastening sections 12, so that according to FIG. 3 this region can also be optimally used for the movement of the hinge system 3, whereby a particularly compact design is achieved.

It is in particular apparent from FIG. 5 that, in a closed position, the first support and fastening system 4 and the second support and fastening system 6 form a stepped spacer gap, wherein the first support and fastening system 4 in some regions has a setoff 32, relative to a horizontal direction perpendicular to the spacer gap, in which the support region 28 of the associated support and fastening section 12 engages as a protrusion.

The first support and fastening system 4 extends in the vertical direction beyond the second support and fastening system 6. From a comparison of FIGS. 1 and 2, it is apparent that the step 11 in cover plates 10 is provided to surround the support and fastening sections 12 at the ends in the vertical direction, which can also make a further contribution to a particularly compact design.

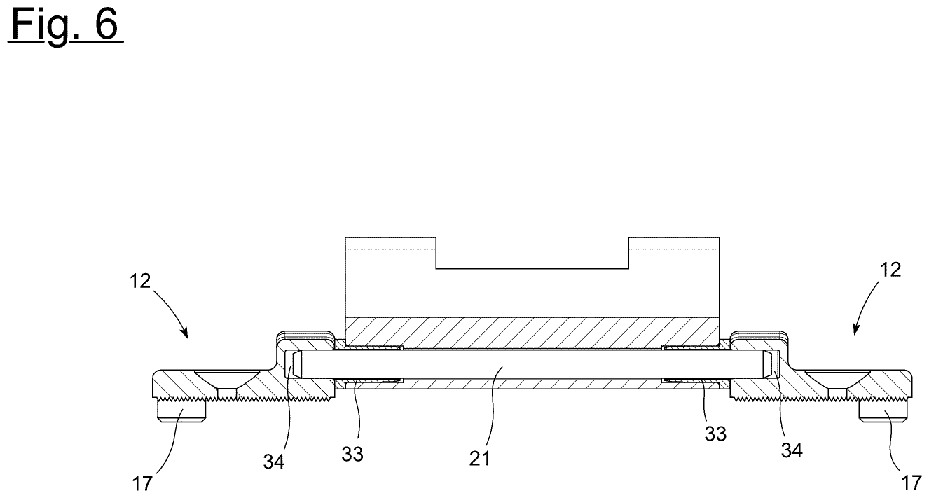

Finally, FIG. 6 shows a longitudinal section along the vertical direction z through the second support and fastening system 6 including the two support and fastening sections 12 and the hinge system 3 held thereon. For the sake of clarity, various parts, in particular the door leaf 1, the door frame 2, the first support and fastening system 4, and part of the hinge system 3, are not shown.

The described shape of the support and fastening sections 12 including the support region 28 and the fastening region 29 is also particularly clearly apparent from FIG. 6.

The longitudinal section shown extends through the fourth pin 21. It is apparent that the fourth pin 21 extends through sleeves 33, which are arranged with a collar between the hinge system 3 and the support and fastening sections 12 adjoining on both sides.

The third pin 20 and the fourth pin 21 can preferably be pressed into corresponding pin receptacles 34 so as to enable a zero-backlash connection and to prevent the support and fastening sections 12 from loosening from the hinge system 3. It is of particular importance that, relative to the door hinge itself, the support and fastening sections 12 are connected exclusively by way of the third and fourth pins 20, 21, and that an indirect connection by way of the door frame 2 or, if necessary, a spacer plate or the like is only added in the assembled state.

The support and fastening sections 12 can be designed as die-cast metal parts, for example. A zinc die casting process is suitable, for example.

It is, in particular, apparent from FIG. 3 that the door hinges of the building door are each inserted with the first support and fastening system 4 into a recess 35 in a narrow side of the door leaf 1, whereby the door hinges are essentially concealed when the door leaf 1 is closed.

The door leaf 1 usually has a weight between 15 kg and 120 kg, and in particular between 20 kg and 80 kg. In particular, the door hinge is designed to have a load-bearing capacity of 80 kg.

1. A door hinge comprising an at least six-pin hinge system, which is connected, on a first side, by way of a first and a second pin extending along a vertical direction to a first support and fastening system with a receiving body and, on a second side, by way of a third and a fourth pin extending along the vertical direction to a second support and fastening system, wherein the second support and fastening system comprises two separate support and fastening sections which are not connected directly but via the third and fourth pins and which are configured to be arranged with a rear fastening surface directly on a door or frame surface.

2. The door hinge according to claim 1, wherein the support and fastening sections have a total thickness, perpendicular to the vertical direction, of between 5 mm and 16 mm and a width between 15 mm and 40 mm.

3. The door hinge according to claim 1, wherein the rear fastening surface has a corrugation and/or at least one centering pin.

4. The door hinge according to claim 1, wherein the support and fastening sections each have exactly one opening for a fastening means.

5. The door hinge according to claim 1, wherein the second support and fastening system is configured for a rigid, non-adjustable arrangement on the door or frame surface.

6. The door hinge according to claim 1, wherein the support and fastening sections each comprise a support region for receiving the third and fourth pins, and a substantially plate-shaped fastening region.

7. The door hinge according to claim 6, wherein the fastening region has a thickness between 2.5 mm and 8 mm.

8. The door hinge according to claim 1, wherein, in a closed position, the first support and fastening system and the second support and fastening system form a stepped spacer gap, the first support and fastening system having a setoff, relative to a horizontal direction perpendicular to the spacer gap, in which the support and fastening sections of the second support and fastening system engage with a protrusion.

9. The door hinge according to claim 1, wherein the first support and fastening system comprises two cover plates which are arranged at the ends along the vertical direction and each have a step.

10. The door hinge according to claim 1, wherein the receiving body of the first support and fastening system has elongated holes for screws for fastening.

11. The door hinge according to claim 1, wherein the first support and fastening system has at least one insert which is adjustable with respect to the receiving body and which receives the first and second pins.

12. The door hinge according to claim 1, wherein the hinge system is designed to have exactly six pins.

13. The door hinge according to claim 12, wherein the hinge system comprises a main arm, a first partial arm, and a second partial arm, the main arm being connected at the first pin to the first support and fastening system so as to be rotatable and displaceable along a guide path and being connected at the third pin to the second support and fastening system so as to be rotatable only, the first partial arm being connected at the second pin (19) to the first support and fastening system (4) so as to be rotatable only, being connected at a fifth pin extending along the vertical direction to the main arm so as to be rotatable, and being connected at a sixth pin extending along the vertical direction to the second partial arm so as to be rotatable, and furthermore the second partial arm being connected at the fourth pin to the second support and fastening system (so as to be rotatable.

14. The door hinge according to claim 1, wherein the support and fastening sections are formed as cast metal parts.

15. The door hinge according to claim 1, wherein a maximum opening angle is 160° to 200°.

16. The door hinge according to claim 15, wherein the maximum opening angle is 180°.

17. A building door comprising a door frame, a door leaf and at least two door hinges according to claim 1.

18. The building door according to claim 17, wherein, on the door hinges, the first support and fastening system is in each case inserted into a recess in a narrow side of the door leaf, the second support and fastening system being placed on a reveal surface of the door frame so that the door hinges are substantially concealed when the door leaf is closed.

19. The building door according to claim 17, wherein the door leaf has a weight between 15 kg and 120 kg.

20. The building door according to claim 17, wherein the second support and fastening systems are fastened to partial surfaces of a flat reveal surface of the door frame.
